(19) United States
(12) Patent Application Publication
(10) Pub. No.: US 2008/0026688 A1
(43) Pub. Date: Jan. 31, 2008

(54) Method and system for maintaining computer and data rooms

(76) Inventors: Paul Musick, Alken, SC (US); Denise Musick, Aiken, SC (US); Kevin Vickery, Columbia, SC (US); Ashlee Vickery, Columbia, SC (US)

Correspondence Address: MCNAIR LAW FIRM, P.A., P.O. BOX 10827, GREENVILLE, SC, 29603-0827, US

(21) Appl. No.: 11/881,016

(22) Filed: Jul. 25, 2007

Related U.S. Application Data
(60) Provisional application No. 60/833,043, filed on Jul. 25, 2006.

(51) Int. Cl. B01L 1/04; A47L 7/00; E04B 5/43

(52) U.S. Cl. 454/187; 15/403; 454/191; 52/126.6

(57) ABSTRACT

This invention comprises a method and kit for maintaining a computer room having a raised flooring system comprising: raising a floor panel from the raised flooring system in the computer room; vacuuming a pedestal and stringer of the raised flooring system revealed by raising the floor panel with a high filtration vacuum; dusting the pedestal and stringer with a microfiber cloth; removing debris from an area under the floor panel; vacuuming the area under the floor panel with the high filtration vacuum; and, returning the floor panel to its original position so that contaminants can be removed from the raised flooring system without compromising the integrity of the flooring system or damaging the equipment within the computer room.

### CROSS-REFERENCE TO RELATED APPLICATION

This application claims priority from U.S. Provisional Patent Application Ser. No. 60/833,043, entitled A Method for Maintaining Computer and Data Rooms, filed Jul. 25, 2006.

### FIELD OF THE INVENTION

This invention is directed to a method and system for maintaining a computer or data room and particularly directed to the cleaning and maintenance of raised or access flooring.

### BACKGROUND OF THE INVENTION

Raised computer, server, and data room floors have become almost a necessity for a high-availability data or server center. Further, data centers and server rooms without raised flooring systems are perceived as being of less quality or sophistication or as less than state of the art. Raised flooring systems were developed to provide for a distribution system for air conditioning, conduits, cabling, ground grids for grounding and to run chilled water or other environmental or computer resources.

With the advent of faster processors, computers are running “hotter”, thereby increasing the need for conditioned cold air and power distribution. A raised floor can assist in satisfying these needs.

A raised or access floor system is an elevated floor having a raised area located above a sub-floor. The raised floor generally consists of two-foot-by-two-foot floor panels. Typically, flooring panels are made from steel sheets welded together and filled with lightweight cement. These floor panels are supported by adjustable support pedestals arranged in grids for supporting the floor panels. The space between the raised floor and the sub-floor provides an area to locate power lines, data lines, environmental systems such as air conditioning, fire detection and suppression, and other such systems. Since the floor panels are easily removable, the sub-floor and associated space can eliminate the need for physical lines running through walls.

Over time, these floor panels become dirty with particulates which settle on and under the raised floor. These particulates can detrimentally affect the operation of the computer and other equipment in the data or service room since the raised floor system may not optimally operate. For example, air conditioning can be run under the raised floor and when the vents in the floor panels become dirty and clogged, the air conditioner does not work as effectively, thus raising the temperature in the data or service room. When the temperature is raised, the operation of a computer located within the data or service room can be detrimentally affected.

Additionally, debris under the flooring system can cause vertical instability in the flooring system, structural damage to the flooring system, create particulates harmful to computer equipment, an unhealthy environment for employees, and can constitute a fire hazard. Sources of debris include printer dust, sheet rock, rust, uncovered concrete, and foot traffic.

Contaminants that have been found to exist in computer rooms include zinc shavings or whiskers, ferrous metals, and metal shavings. Zinc whiskers are tiny crystalline strands of zinc that grow on the surface of electroplated steel. Whiskers have been found growing on electroplated components of computer hardware, cabinets and racks as well as on some galvanized-pan access floor panels. The electrically conductive whiskers can break free, become airborne and be transported into the computer equipment—causing short circuits, voltage variances, and other signal disturbances. These events are capable of causing equipment service interruptions or failures.

There are several factors that have contributed to the increased concern and damage caused by contaminants such as zinc whiskers. First, after years of growth, these contaminants become large enough to more easily break free from the surfaces where they are growing. Second, the size of circuits and other electrical components has been reduced therefore shortening the gap between contacts where zinc whiskers can cause a short.

Therefore, it is recommended that a detailed cleaning of the raised flooring be performed periodically to assist with the elimination of airborne contaminants and particulate which can clog computer circuitry, increase the risk of fire, accidental activation of fire suppression equipment, particularly halon discharge, and contribute to a range of health problems concerning employees. Contaminates and particulates such as dust and dirt are abrasive to floor panels surfaces and harmful to sensitive equipment. Accumulated contaminants such as concrete dust, rust flakes, sheetrock dust, sand and carbon particles can be swept up and contaminate equipment by the very environmental controls of a raised floor system itself and further be carried into the work space.

Keeping the raised floor system clean is especially important for maintaining its conductive properties related to grounding. Cleaning of raised floors is necessary to prevent unwanted dust and dirt below the raised floor from contaminating air conditioning equipment. Failure to properly clean a raised floor system can result in damaging particulates that can create computer failures which can result in costly downtime. Further, failure to properly use the correct methods or equipment to clean the raised floor can result in a raised floor system that is prone to static electricity and airborne particles. For example, failure to use the proper Raised Floor Cleaning Solution with anti-static gloves and wipes to thoroughly clean hardware can again increase the risks of conductive electric charge and contamination.

Once proper cleaning is performed, there is also a need for environmental reporting which includes the result of the proper cleaning as well as potential risks such as the presence of destructive contaminants. Performing a baseline for measuring the effectiveness of the cleaning allows for the measurement of the effectiveness of all subsequent cleanings. The environmental reporting can be accomplished using a particle counter. For example, a handheld laser particle counter can be used to measure contaminants within a computer room.

Therefore, there is a need to have a method for cleaning a raised floor that meets the specific needs of a raised floor system designed for use with data or server rooms. Further, simply using water or liquid detergents directly on the access flooring can damage the flooring and its conductive properties. Water can be damaging for use under the floor and particular care should be taken when removing floor panels so as not to degrade the integrity of the flooring system. Further, alkaline detergents, soda, soaps, and solvents as well as pumice-stone, sandpaper, steel wool or other abrasives can cause permanent damage to the flooring system and its operation.

### DESCRIPTION OF THE DRAWINGS

FIG. 1 is a perspective of a raised flooring system;

FIG. 1A is a perspective of the flooring system;

FIG. 2 is a flowchart of the step of the present invention;

FIG. 3 is a flowchart of the steps of the present invention; and,

FIG. 4 is a flowchart of the steps of the present invention.

### SUMMARY OF THE INVENTION

This invention comprises a method for maintaining a computer room having a raised flooring system comprising: raising a floor panel from the raised flooring system in the computer room; vacuuming a pedestal and stringer of the raised flooring system revealed by raising the floor panel with a high filtration vacuum; dusting the pedestal and stringer with a microfiber cloth; removing debris from an area under the floor panel; vacuuming the area under the floor panel with the high filtration vacuum; and, returning the floor panel to its original position so that contaminants can be removed from the raised flooring system without compromising the integrity of the flooring system or damaging the equipment within the computer room.

This invention can also include taking pre-cleaning environmental readings prior to cleaning the computer room for measuring the presence of contaminants in the computer room; taking post-cleaning environmental readings after cleaning the computer room for measuring the presence of contaminants in the computer room; and, comparing the pre-cleaning and the post-cleaning environmental readings so that the effect of the cleaning of the computer environmental can be measured.

This invention can also include determining if mechanical cleaning of the top surface of the floor panel of the raised flooring system is required; and if mechanical cleaning of the top surface of the floor panel is required, providing a mechanical floor cleaning apparatus having brushes with a vacuum extraction member for extracting debris into a collection tank carried by the mechanical floor cleaning apparatus and cleaning the floor panel of the raised floor system with the mechanical floor cleaning apparatus.

This invention can also include providing a mechanical floor cleaning apparatus having a mister for misting liquid on the floor panel of the raised floor system wherein the vacuum extraction member extracts the misted liquid from the floor panel into the collection tank.

This invention can also include applying a cleaning solution to the floor panels of the raised flooring system; waiting at least ten minutes after the cleaning solution has been applied to the floor panel; extracting the cleaning solution from the floor panels into the collection tank with the vacuum extraction member; and, emptying the collection tank when between 300 and 450 square feet of floor panels have been cleaned.

This invention can also include providing at least one microfiber pad; pre-treating the microfiber pad with a cleaning solution; cleaning at least one floor panel of the raised flooring system with the microfiber pad, providing a mop having a mop head; placing the microfiber pad on the mop head wherein the cleaning at least one floor panel includes cleaning at least one floor panel with the mop and microfiber pad and affixing an electrostatic grounding strap to a technician to prevent a buildup of an electric charge caused by movement of the technician.

This invention can include a cleaning kit for maintaining a computer room having a raised flooring system comprising: a cleaning kit transportation unit having: an electrostatic grounding strap for attaching to a technician to prevent buildup of an electric charge caused by movement of the technician; a high filtration vacuum for vacuuming floor panels, pedestals, stringers, and sub-floors; a set of microfiber clothes, a mechanical floor cleaning apparatus having a vacuum extraction member for extracting debris into a collection tank, a mister carried by the mechanical floor cleaning apparatus for misting a liquid on the floor panels of the raised flooring system, a plurality of microfiber pads; a cleaning solution for applying to the microfiber pad for cleaning the floor panels; a plurality of microfiber cloths; a cleaning solution for applying to the microfiber cloth for cleaning the raised flooring system, and markers for affixing to walls of the computer room for designating areas of the computer room to be cleaned.

This invention can also include designating a section of the computer room and a second section of a computer room to be cleaned; marking the walls of the computer room to indicate the section determined to be cleaned; raising a floor panel from the raised flooring system in the designated section of the computer room; vacuuming a pedestal and stringer of the raised flooring system revealed by raising the floor panel with a high filtration vacuum; dusting the pedestal and stringer with a microfiber cloth; removing debris from an area under the floor panel; vacuuming the area under the floor panel with the high filtration vacuum; and, returning the floor panel to its original position so that contaminants can be removed from the designated section without compromising the integrity of the flooring system or damaging the equipment within the computer room.

### DESCRIPTION OF THE INVENTION

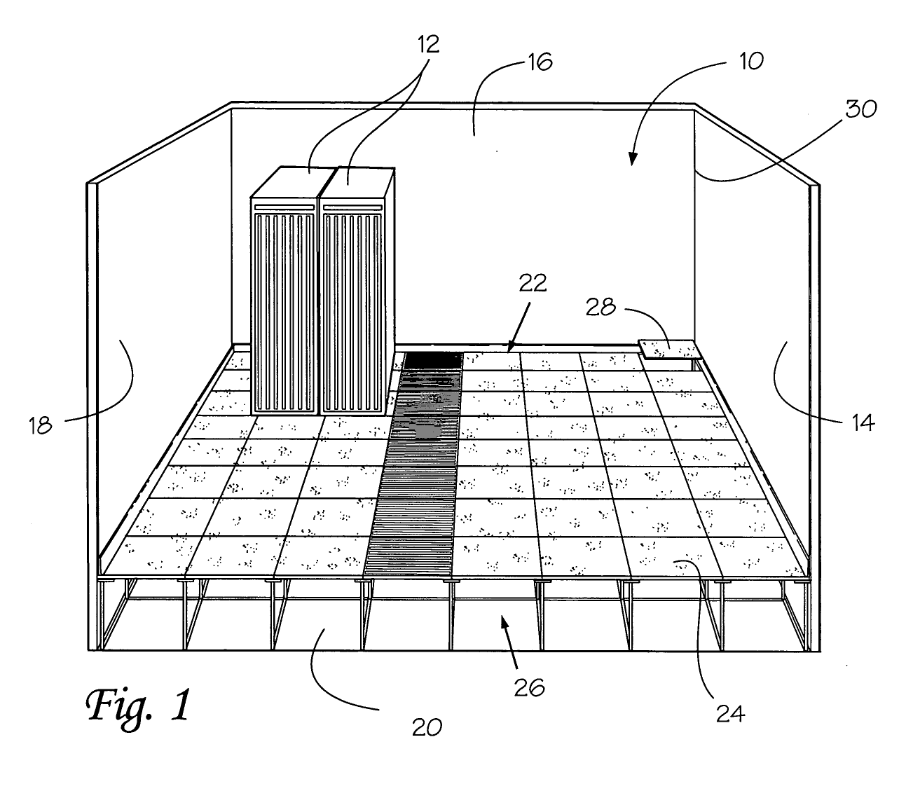

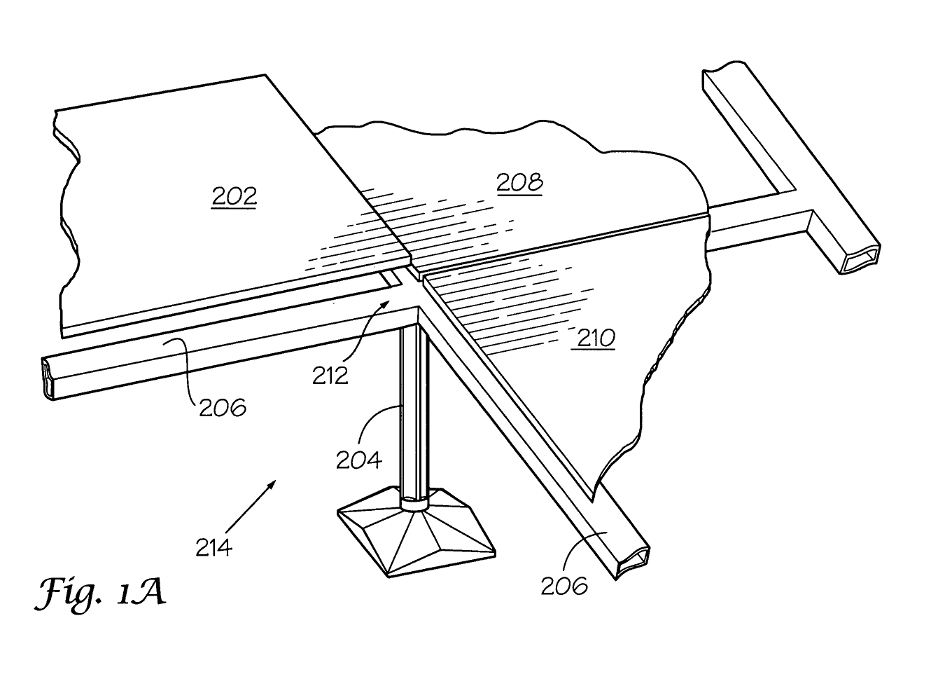

Referring now to FIG. 1, the data room is shown generally as 10. Servers 12 are located in data room. Data room 10 includes a first wall 14, a second wall 16, a third wall 18 and a fourth wall (not shown). The data room also comprises a sub-floor 20 and a raised floor generally shown as 22. The raised floor comprises individual 2′×2′ floor panels 24. The area between the sub-floor and the raised floor, generally shown as 26, is provided for the placement of power lines, data lines and environmental systems such as air-conditioning, fire detection and suppression systems.

Referring to FIG. 1A, the skeleton of a raised flooring system is shown. Floor panel 202 is shown raised off the sub-floor by the pedestal 204 and stringers 206. Contaminants can fall between the floor panels 202, 208, and 210 and rest in area shown generally as 212. Therefore, contaminants need to be removed from the pedestal, stringers, and sub-floor 214.

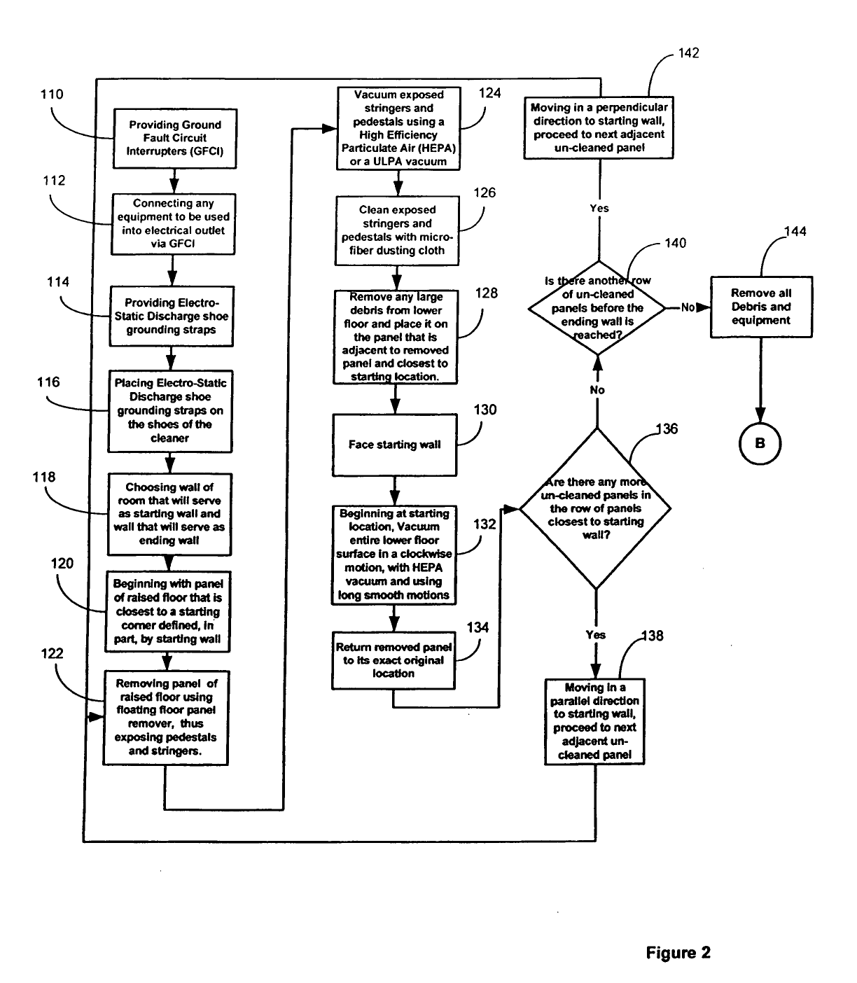

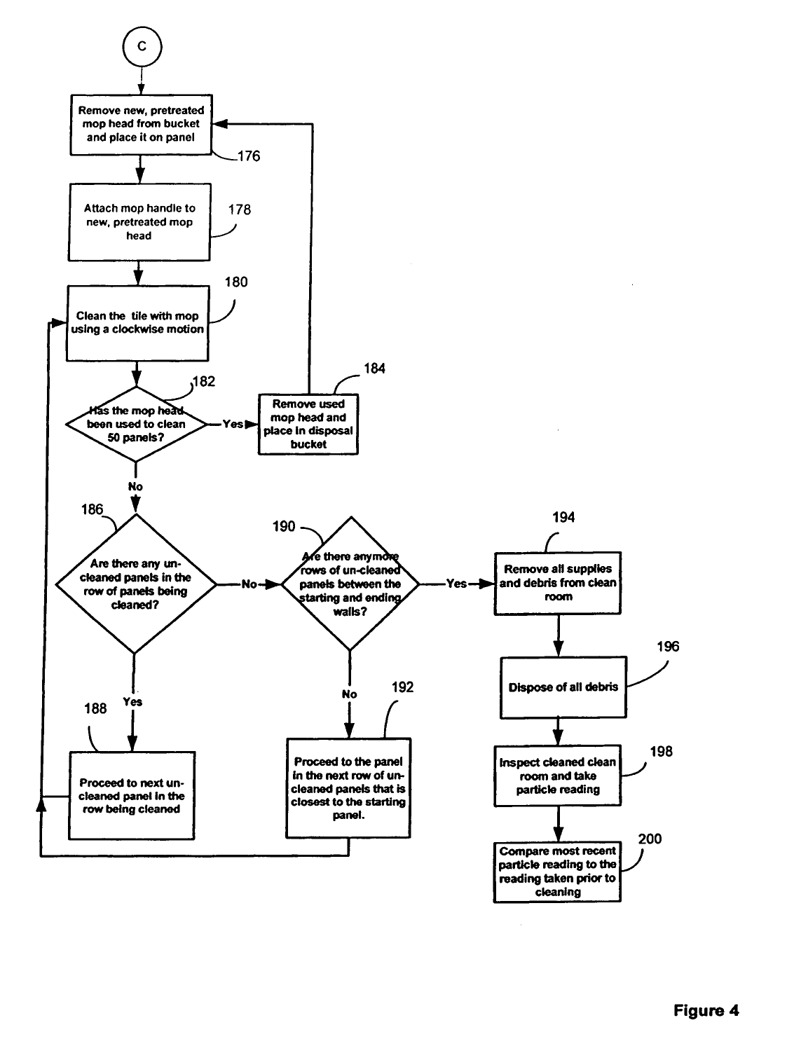

As will be more fully discussed in reference to FIG. 2-4, the technician can choose a starting tile 28, which is located in the starting corner 30.

Referring now to FIG. 2, the steps of the method for cleaning a raised flooring system in a computer server or data room are illustrated. It is desirable for any equipment to be used in performing the steps for cleaning a raised flooring system to be connected to a device such as a ground fault circuit interrupter to prevent electrical surges. Therefore, at 110, the technician provides a ground fault circuit interrupter and connects any electrical equipment to be used during the cleaning process to a designated electrical outlet via the ground fault circuit interrupter at 112.

At steps 114 and 116, the technician obtains electrostatic discharge shoe grounding straps and places them on his shoes to prevent the technician from building an electrical static charge that could discharge and cause an overload or other electrical problems with the electronic equipment located in the room being cleaned.

Once the technician has ensured that neither the equipment used by the technician nor the technician himself will create electrical surges that could adversely affect the electrical equipment located in the data/server room, he may enter the room to begin cleaning.

First, the technician should choose one of the four walls of the room that will serve as a starting wall and another wall that will serve as the ending wall at step 118. If more than one technician is cleaning the room, the technicians should position place markers along the starting wall to designate the area for which each technician is responsible. To ensure that the room is completely cleaned, each technician's area should overlap with at least one other technician's area.

At step 120, the technician begins the cleaning process with the floor panel that is closest to the starting corner. The starting corner can be either of the corners defined, in part, by the starting wall. In the case of multiple technicians, however, the starting corner can be defined by one of the place markers that defines the technician's area to be cleaned. Beginning with the starting floor panel, the technician raises the floor panel and slides it over from its original position at step 122 with access panel lifter.

By removing the floor panel, the technician exposes the sub-floor and support structure for the floor panels. Careful attention must be taken to observe the support structure also called a plenum which includes pedestals and stringers. There could be cable trays, power cords, cables, fire monitors, water monitors, debris, water or other obstacles that must not be damaged. The technician then uses a High Efficiency Particulate Air (HEPA) vacuum to vacuum each surface of the exposed stringers and pedestals at 124.

After vacuuming the pedestals and stringers, the technician dusts each surface of the pedestals and stringers with a microfiber cloth at 126. The technician then manually removes any large debris that would not be effectively cleaned by the HEPA or ULPA vacuum from the sub-floor at step 128. The technician should place the debris removed from the sub-floor on one of the floor panels located adjacent to the removed floor panel. Preferably, the technician will place the debris on the adjacent floor panel that is closest to the starting wall.

Once all of the large debris has been removed, the technician proceeds to face the starting wall at step 130 and then vacuums the sub-floor at step 132. Preferably, the technician will use long, smooth, clockwise vacuuming motions to clean the sub-floor surface.

Once the area below the starting floor panel has been cleaned, the technician uses the access panel lifter to return the removed floor panel to the floor panel's original location at step 134. Returning the removed floor panel back to its previous location is important because misplacing the floor panel can alter the flooring system, thus creating instability in the raised floor.

After replacing the floor panel, the technician must determine if the floor panel previously cleaned is the last panel to be cleaned. To do so, the technician must first ask, at step 136, if there are any more un-cleaned panels in the row currently being cleaned. A row is defined as a line of panels that extends in a direction parallel to the starting wall. If the answer is yes, step 138 requires the technician to move in a direction parallel to the starting wall to the next un-cleaned panel in the row of panels and repeat steps 122 through 134.

However, if there are no more un-cleaned panels in the row of panels being cleaned, step 140 requires the technician to ask if there is another row of un-cleaned panels between the starting wall and the ending wall. If the answer is yes, step 142 requires the technician to proceed, in a direction that is perpendicular to the starting wall, to the panel in the next row of un-cleaned panels that is closest to the starting panel and repeat steps 122 through 134. The technician will repeat this process until each panel in each row of the raised flooring system has been cleaned.

If there are no more rows of un-cleaned panels between the starting wall and the ending wall and no more panels in the row being cleaned, the technician has successfully completed cleaning both the raised floor system, including the area beneath each of the raised floor panels, that require cleaning. Therefore, the technician should remove all debris collected and any equipment used from the room at step 144.

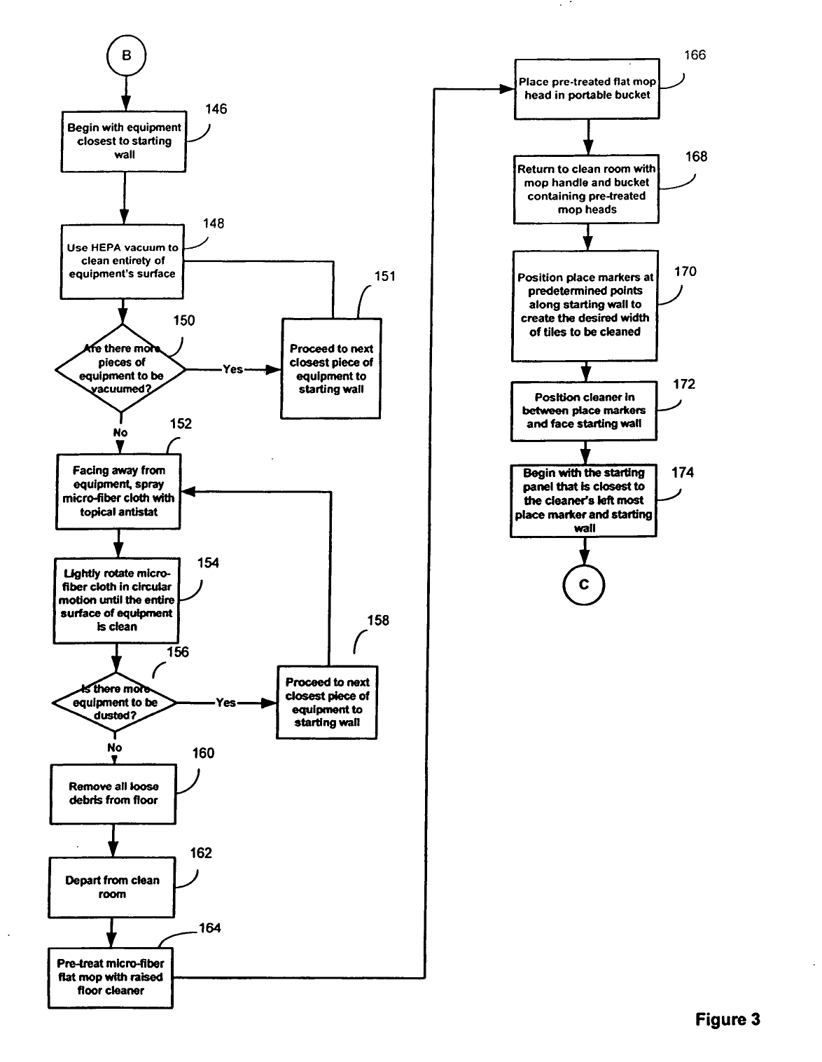

Referring now to FIG. 3, the steps for cleaning above the raised flooring system of a computer server or data room are illustrated. At step 146, the technician will begin at the designated starting wall and determine which piece of equipment is closest to the starting wall. The technician will then proceed to use a high filtration vacuum such as a HEPA or ULPA vacuum to vacuum each surface of the equipment being cleaned at step 148. Once the piece of equipment has been vacuumed, the technician must determine whether any other un-cleaned pieces of equipment exist in the room that require cleaning. Step 150 requires the technician to ask if there are more pieces of equipment to be vacuumed. If the answer is yes, the technician proceeds to the next piece of un-cleaned equipment that is closest to the starting wall at step 151 and repeats step 148.

However, if there are no more pieces of equipment to be vacuumed, the technician may proceed to dust the equipment. At step 152, the technician faces away from the place of equipment to be cleaned and sprays a microfiber cloth with topical cleaning solution. At step 154, the technician may begin dusting the equipment's surface with the micro-fiber cloth, preferably using a circular motion until the entire surface area of the equipment has been dusted. Once the equipment is dusted, the technician must determine if there are any more pieces of equipment to be dusted at step 156. If the answer is yes, step 158 requires the technician to proceed to the next closest piece of equipment to the starting wall and repeat steps 152 through 154. If there are no more pieces of equipment to be dusted, the technician should remove all loose debris from the floor at step 160. Taking the debris with him, the technician should depart the cleaning room at step 162.

At this point, the technician must decide upon the degree of raised floor panel contamination. If the panels require more scrubbing than the mopping system can provide, then a mechanical cylindrical brush floor cleaner with vacuum extraction should be used. This floor machine has two cylindrical brushes that clean the panels of the raised flooring. A built in mister sprays clean water on the floor, which is immediately vacuumed up into a collection tank. If the technician decides to use the mechanical floor cleaner. He must leave the raised flooring area. The technician should then place clean water in the water tank of the mechanical floor cleaner then the technician should put raised floor cleaning solution into a separate spray applicator and return to the raised floor area. Locate the starting wall. With safety cones and “wet floor” signs mark off two rows of raised floor tile that does not exceed 200 panels or 400 sq. ft. Apply a fine mist of the raised floor cleaning solution to the tiles with the spray applicator. Let the chemical remain on the floor for ten to fifteen minutes. Plug in the mechanical floor cleaner and begin at the starting wall. Walking behind the mechanical floor cleaner, the technician will slowly move towards the ending wall. At the end of each column, the technician will inspect the floor, move the safety cones, and spray the raised floor cleaning solution onto the next 200 panels or 400 sq ft of untreated floor area. They will work in a back and forth direction until the entire raised flooring area is clean. Every measure must be taken to prevent water from accumulating on the floor other than a misted coverage. The collection tank must be emptied after each 400 sq ft area is completed. Please note that a water collection pan must be placed under the mechanical floor cleaner if it is not in operation while in the data center to prevent unwanted water from leaking on to the floor.

The technician can then prepare to mop the panels of the floor of the cleaning room using what H₂0 or cleaner. In this step, there should be no water in the room as it risks damaging, if not destroying, the equipment located in the room. Computers and circuits can be damaged by water since water can cause a short across the contacts. Therefore, the technician must pre-treat at least one microfiber pad with a raised floor panel cleaning solution while outside the room at step 164. Because a microfiber pad should only be used to clean 50 panels before being replaced, the technician will pre-treat as many microfiber pads as will be necessary to clean the desired area of the raised floor at step 164. After treating the microfiber pads, the technician will place them in a portable bucket at step 166. At step 168, the technician will return to the room with a mop handle and the bucket of pre-treated microfiber pads and a disposal bucket.

Before mopping the panels, the technician positions place markers at predetermined points along the starting wall so as to designate the width of the area of panels to be cleaned at step 170. In cases where there are two or more technicians, the place markers will designate the areas for which each technician is responsible for cleaning. To ensure that the entire floor is cleaned, each technician's section should overlap with at least one other technician's section. However, if just one technician is cleaning the room, the place markers could be placed at edges of the room or could even comprise the walls connecting the starting to the ending wall assuming no more than a 50 panel width.

Once the technician's section has been determined, the technician will face the starting wall and position himself at the left most place marker at step 172. Beginning with the panel closest to the starting wall and the left most place marker, which is known as the starting corner, the technician will remove the pre-treated microfiber pad from the bucket and place it on the starting panel at steps 174 and 176. At steps 178 and 180, the technician will attach the microfiber pad to the mop handle and begin cleaning the starting panel, preferably using a clockwise motion.

The technician must remain vigilant to ensure that the microfiber pad has not been used to clean more than 50 panels. Therefore, at step 182 the technician must ask himself if the mop has been used to clean 50 panels. If the answer is yes, the technician must remove the old microfiber pad, place it in the disposal bucket at step 184, and replace it will a new, pre-treated microfiber pad at steps 176 and 178. Once the microfiber pad is replaced or if it does not need replacement, the technician should continue cleaning the panels of the room.

At step 186, the technician must ask himself if there are any un-cleaned panels in the row of panels being cleaned. If there is at least one un-cleaned panel in the row being cleaned, the technician proceeds to clean the next un-cleaned panel at step 188 and repeat steps 180 through 186. The technician should repeat this process until all of the panels in the row being cleaned have been mopped. Once the entire row of panels is clean, the technician must ask himself if there are any more rows of un-cleaned panels located between the starting wall and ending wall at step 190. If there is at least one row of un-cleaned panels left, step 192 requires the technician to proceed to the panel in the next row of un-cleaned panels that is closest to the starting panel and repeat steps 180 through 188 until there are no more rows of un-cleaned panels between the starting and finishing walls.

Once all of the panels have been cleaned, the technician should remove all supplies and debris from the room at step 194. At step 196, the technician disposes of all the debris.

The materials used to perform the steps described herein can be carried to and from job locations in a cleaning kit transportation unit. The cleaning kit transportation unit can have predetermined locations within the kit to hold the various supplies. The cleaning kit can vary in size and be a hard pushable apparatus or vehicle trailer.

At step 198, the technician will inspect the room and take a particle reading measuring the number of dust particles in the air. The technician will then compare the particle reading to a reading that was taken prior to the cleaning at step 200.

While a preferred embodiment of the invention has been described using specific terms, such description is for illustrative purposes only, and it is to be understood that changes and variations may be made without departing from the spirit or scope of the following claims.

What is claimed is:

1. A method for maintaining a computer room having a raised flooring system comprising:
raising a floor panel from the raised flooring system in the computer room;
vacuuming a pedestal and stringer of said raised flooring system revealed by raising the floor panel with a high filtration vacuum;
dusting the pedestal and stringer with a microfiber cloth;
removing debris from an area under the floor panel;
vacuuming the area under the floor panel with the high filtration vacuum; and,
returning the floor panel to its original position so that contaminants can be removed from the raised flooring system without compromising the integrity of the flooring system or damaging the equipment within the computer room.

2. The method of claim 1 including:
raising a second floor panel from the raised flooring system in the computer room after replacing the previous floor panel to its original position;
vacuuming a pedestal and stringer of said raised flooring system revealed by raising the second floor panel with a high filtration vacuum;
dusting the pedestal and stringer with a microfiber cloth;
removing debris from an area under the second floor panel; and,
vacuuming the area under the second floor panel with the high filtration vacuum.

3. The method of claim 1 including:
taking pre-cleaning environmental readings prior to cleaning the computer room for measuring the presence of contaminants in the computer room;
taking post-cleaning environmental readings after cleaning the computer room for measuring the presence of contaminants in the computer room; and,
comparing the pre-cleaning and the post-cleaning environmental readings so that the effect of the cleaning of the computer environmental can be measured.

4. The method of claim 1 including:
determining if mechanical cleaning of the top surface of the floor panel of the raised flooring system is required; and
if mechanical cleaning of the top surface of the floor panel is required, providing a mechanical floor cleaning apparatus having brushes with a vacuum extraction member for extracting debris into a collection tank carried by the mechanical floor cleaning apparatus and cleaning the floor panel of the raised floor system with the mechanical floor cleaning apparatus.

5. The method of claim 4 including providing a mechanical floor cleaning apparatus having a mister for misting liquid on the floor panel of the raised floor system wherein the vacuum extraction member extracts the misted liquid from the floor panel into said collection tank.

6. The method of claim 4 including:
applying a cleaning solution to the floor panels of the raised flooring system;
waiting at least ten minutes after the cleaning solution has been applied to the floor panel;
extracting the cleaning solution from the floor panels into the collection tank with the vacuum extraction member; and,
emptying the collection tank when between 300 and 450 square feet of floor panels have been cleaned.

7. The method of claim 1 including:
providing at least one microfiber pad;
pre-treating the microfiber pad with a cleaning solution; and,
cleaning at least one floor panel of the raised flooring system with the microfiber pad.

8. The method of claim 7 including:
providing a mop having a mop head; and,
placing the microfiber pad on the mop head wherein said cleaning at least one floor panel includes cleaning at least one floor panel with the mop and microfiber pad.

9. The method of claim 6 including replacing the microfiber pad with a second microfiber pad when between forty and fifty-five floor panels have been cleaned.

10. The method of claim 1 including affixing an electrostatic grounding strap to a technician to prevent a buildup of an electric charge caused by movement of the technician.

11. A cleaning kit for maintaining a computer room having a raised flooring system comprising:
a cleaning kit transportation unit having:
an electrostatic grounding strap for attaching to a technician to prevent buildup of an electric charge caused by movement of the technician;
a high filtration vacuum for vacuuming floor panels, pedestals, stringers, and sub-floors; and,
a set of microfiber clothes.

12. The kit of claim 11 including a mechanical floor cleaning apparatus having a vacuum extraction member for extracting debris into a collection tank.

13. The kit of claim 12 including a mister carried by said mechanical floor cleaning apparatus for misting a liquid on the floor panels of the raised flooring system.

14. The kit of claim 11 including:
a plurality of microfiber pads; and,
a cleaning solution for applying to said microfiber pad for cleaning said floor panels.

15. The kit of claim 11 including:
a plurality of microfiber cloths; and,
a cleaning solution for applying to said microfiber cloth for cleaning said raised flooring system.

16. The kit of claim 11 including markers for affixing to walls of the computer room for designating areas of the computer room to be cleaned.

17. A method for maintaining a computer room having a raised flooring system comprising:
designating a section of the computer room to be cleaned;
marking the walls of the computer room to indicate the section determined to be cleaned;
raising a floor panel from the raised flooring system in the designated section of the computer room;
vacuuming a pedestal and stringer of said raised flooring system revealed by raising the floor panel with a high filtration vacuum;
dusting the pedestal and stringer with a microfiber cloth;
removing debris from an area under the floor panel;
vacuuming the area under the floor panel with the high filtration vacuum; and,
returning the floor panel to its original position so that contaminants can be removed from the designated section without compromising the integrity of the flooring system or damaging the equipment within the computer room.

18. The method of claim 17 including:
designating a second section of the computer room which overlaps the previously designated section;
marking the walls of the computer room to indicate the second section;
raising a second floor panel from the raised flooring system in the second section of the computer room;
vacuuming a second pedestal and stringer of said raised flooring system revealed by raising the second floor panel with the high filtration vacuum;
dusting the second pedestal and stringer with the microfiber cloth;
removing debris from an area under the second floor panel;
vacuuming the area under the second floor panel with the high filtration vacuum; and,
returning the second floor panel to its original position so that contaminants can be removed from the second section.

19. The method of claim 17 including:
taking pre-cleaning environmental readings prior to cleaning the computer room for measuring the presence of contaminants in the computer room;
taking post-cleaning environmental readings after cleaning the computer room for measuring the presence of contaminants in the computer room; and,
comparing said pre-cleaning and said post-cleaning environmental readings so that the effect of the cleaning of the computer environmental can be quantified.

20. The method of claim 17 including:
determining if mechanical cleaning of the top surface of the designated section of the raised flooring system is required;
if mechanical cleaning of the top surface of the designated section is required, providing a mechanical floor cleaning apparatus having brushes with a vacuum extraction member for extracting debris into a collection tank carried by said mechanical floor cleaning apparatus and cleaning said floor panel of the raised floor system with the mechanical floor cleaning apparatus;
determining if mechanical cleaning of the top surface of the second section of the raised flooring system is required; and,
if mechanical cleaning of the top surface of the second section is required, providing a mechanical floor cleaning apparatus having brushes with a vacuum extraction member for extracting debris into a collection tank carried by said mechanical floor cleaning apparatus and cleaning said floor panel of the raised floor system with the mechanical floor cleaning apparatus.

21. The method of claim 20 including providing a mechanical floor cleaning apparatus having a mister for misting liquid on the floor panels of the raised flooring system wherein the vacuum extraction member extracts the misted liquid from the floor panels into the collection tank.

22. The method of claim 21 including emptying the collection tank when between 300 and 450 square feet of floor panels have been cleaned.

23. The method of claim 17 including:
providing at least one microfiber pad;
pre-treating the microfiber pad with a cleaning solution; and,
cleaning at least one floor panel of the raised flooring system with the microfiber pad.

24. The method of claim 23 including:
providing a mop having a mop head; and,
placing the microfiber pad on the mop head wherein said cleaning at least one floor panel includes cleaning at least one floor panel with the mop and microfiber pad.

25. The method of claim 23 including replacing the microfiber pad with a second microfiber pad when between forth and fifty-five floor panels have been cleaned.

26. The method of claim 17 including affixing an electrostatic grounding strap to a technician to prevent a buildup of an electrical charge caused by movement of the technician.
